(19) United States
(12) Patent Application Publication
(10) Pub. No.: US 2010/0045662 A1
(43) Pub. Date: Feb. 25, 2010

(54) METHOD AND SYSTEM FOR DELIVERING AND INTERACTIVELY DISPLAYING THREE-DIMENSIONAL GRAPHICS

(75) Inventors: Christopher C. Boothroyd, Vancouver (CA); Kenney Wong, Richmond (CA); Corey Auger, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: AFTERCAD SOFTWARE INC., Vancouver, BC (CA)

(21) Appl. No.: 12/443,867

(22) PCT Filed: Oct. 2, 2007
(86) PCT No.: PCT/CA07/01759

§ 371 Date: Aug. 20, 2009

Related U.S. Application Data
(63) Continuation of application No. 60/827,833, filed on Oct. 2, 2006.

(51) Int. Cl. G06F 3/048; G06F 15/16; G06T 15/00; G09G 5/00

(52) U.S. Cl. 345/419; 715/733; 345/661; 345/522

(57) ABSTRACT

A method is provided whereby the user can view and interact with live, realtime 3D content using just a web browser, requiring no extra downloads or third party 3D plugins. The invention uses W3C standard bitmap formats, typically JPEG or PNG, as the delivery vehicle for server side rendered 3D content. The invention provides a 3D rendering application that runs on a web server and responds to commands from the user's web browser to manipulate, re-render and deliver new 3D rendered scenes back to the users' browser. The invention preferably uses Ajax—Asynchronous Javascript and XML to create the client side Web 3D scene manipulation tool set.

### CROSS REFERENCE TO RELATED APPLICATION

The present application claims the benefits, under 35 U.S.C. § 119(e), of U.S. Provisional Application Ser. No. 60/827,833 filed Oct. 2, 2006 entitled “Method and System for Delivering and Interactively Displaying Three-dimensional Graphics” which is incorporated herein by this reference.

### TECHNICAL FIELD

The invention relates to the communication and interactive display of electronic graphics and in particular to the communication and interactive display of three-dimensional (“3D”) computer graphics.

### BACKGROUND

Realtime 3D model interaction is emerging as a first-class media type for the web. Network bandwidth and graphics hardware processing power are now sufficiently advanced to enable compelling web-based 3D experiences for AEC/FM, manufacturing, GIS applications, games, online virtual worlds, simulations, education, training and many more applications. Commercial developers and media publishers are expressing increasing interest in exploiting realtime 3D model interaction in web-based applications to enhance production value, create engaging immersive experiences, deliver information in a more meaningful way and allow the user to interact and add to the 3D content.

While much infrastructure has been put into place to enable professional Web 3D deployment in a cross-platform, open, royalty-free environment, there remains the client side software legacy of multiple 3D viewers written by different vendors, to different 3D standards for different operating systems. Such a diversity in client-side 3D viewers presents the user with a bewildering conundrum of technological choices to make and severely dampens the ability of 3D data to find a single pervasive technical platform for publishing to the masses. This coupled with security concerns over installing third party 3D viewers written in Java or ActiveX for example, have dampened the Web 3D revolution to a handful of professionals and enthusiasts. There is therefore a need for a method whereby the user can view and interact with live, realtime 3D content using just a web browser, requiring no extra downloads or third party 3D plugins.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention provides a method whereby the user can view and interact with live, realtime 3D content using just a web browser, requiring no extra downloads or third party 3D plugins. The invention uses W3C standard bitmap formats, typically JPEG or PNG, as the delivery vehicle for server side rendered 3D content.

The invention provides a 3D rendering application that runs on a web server and responds to commands from the user's web browser to manipulate, re-render and deliver new 3D rendered scenes back to the users' browser. The invention preferably uses Ajax—Asynchronous Javascript and XML to create the client side Web 3D scene manipulation tool set.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating the current method for a user to interactively view 3D graphics over the Internet;

FIG. 2 is a schematic diagram illustrating the method for a user to interactively view 3D graphics over the Internet according to the invention;

FIG. 3 is an image of a screen display illustrating the method of the invention;

FIGS. 4 and 5 are diagrams illustrating the method of the invention;

FIG. 6 is a schematic diagram illustrating the method of the invention;

FIGS. 7, 8 and 9 are diagrams illustrating the method of the invention;

FIGS. 10 and 11 is are images of screen displays illustrating the method of the invention;

FIG. 12 is a flow chart illustrating a round-robin rendering algorithm; and

FIG. 13 illustrates a display to the client of eight pre-rendered frames.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

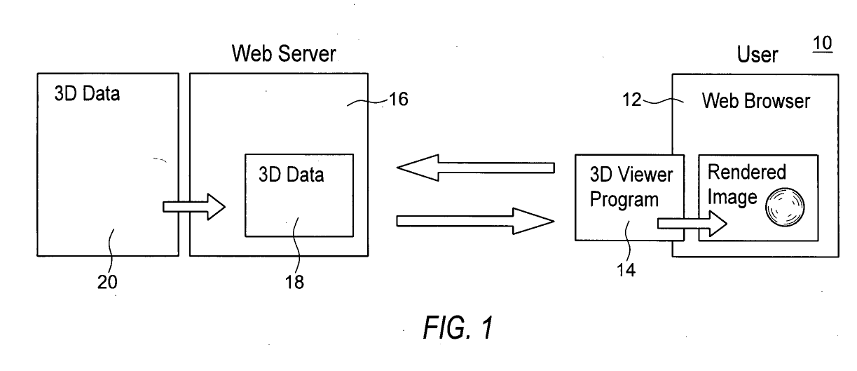

FIG. 1 illustrates schematically the traditional Web 3D delivery method. A client/user 10 has a web browser 12 having a 3D viewer plug-in program 14. User 10 requests a 3D image over the Internet from web server 16 which retrieves all of the 3D data 18 from 3D data source 20 for the image and delivers it to the user's 3D viewer program 14. The plug-in program 14 then renders the 3D image from the 3D data 18 for display on the user's display, and the user generates selective views through the operation of the 3D plug-in 14 on the 3D data 18.

A problem with the traditional method is that the client may not have the appropriate 3D viewer plug-in since there are multiple 3D viewers written by different vendors, to different 3D standards for different operating systems. So the client may be required to download a suitable plug-in 3D viewer to view the image.

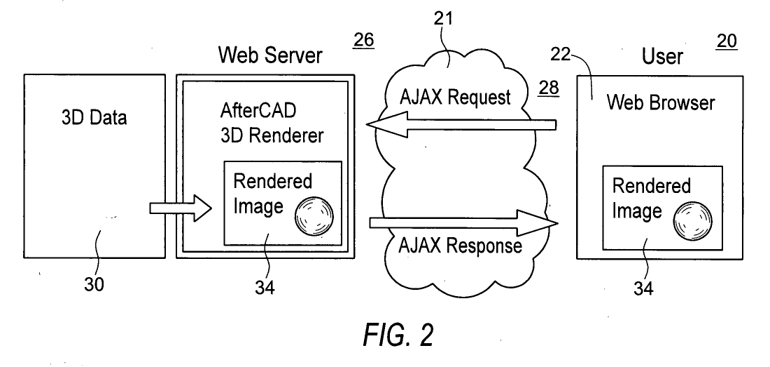

FIG. 2 illustrates schematically the method for a user to interactively view 3D graphics over the Internet according to the present invention. User 20 has access to the Internet 21, via a computer which has in memory standard web browser software 22 such as Internet Explorer™ or Firefox™ to access the World Wide Web. In this case, client/user 20 has a web browser 22 without any specific 3D viewer plug-in programs. User 20 requests a 3D image over the Internet from web server 26 in the form of an AJAX (Asynchronous Javascript and XML) Request 28. Upon receipt of the request, web server 28 retrieves the 3D data from 3D data source 30 and using 3D rendering software 32 renders the requested image in standard bitmap formats, typically in the form of .jpeg file 34 (“JPG” or “JPEG”) or PNG file, which it delivers to the user's browser 22 in the form of an AJAX response. The user's web browser can display the .jpeg image without special 3D viewing software.

In the preferred embodiment of the invention, the 3D data in data source or database 30 is saved in COLLADA™ based format or other open format. Collada is an XML based, Open Source format which is supported by all CAD vendors. Collada supports more geometric and informatic features such as links, annotations and parallel XML namespaces than other formats. Files received from vendors such as Google SketchUp and Google earth can be converted to and saved in Collada-based format and rendered from that format.

The process thus involves the presentation and control of 3D data over a web connection without plugins or third party software. This process offloads the tasks of positioning and rendering a scene to the server while allowing the client to interface with the server given a set of AJAX controls. These AJAX controls allow the user to interact with the scene, while only sending the data necessary for the server to re-render the scene. The AJAX controls then take this newly rendered raster image and display it to the user.

Thus this invention provides a method whereby the user can view and interact with live, realtime 3D content using just a web browser, requiring no extra downloads or third party 3D plugins to support the experience. It identifies the web browser as a stable technology platform for mass publishing of 3D data. The modern web browser is based on technical standards published by the W3C, and as such any web browser, regardless of developer or platform, must adhere completely to the W3C standards (such as HTML, JavaScript, XML etc) to function properly. One of the standards that web browsers use to display graphical content is the JPEG file. This bitmap file format supports much of the visual and photographic content of the Internet and is a stable technology standard viewable by any browser. The invention uses W3C standard bitmap formats, typically JPEG, as the delivery vehicle for server side rendered 3D content.

The invention provides its own 3D rendering application that runs on Web server 26 and responds to commands from the user's web browser to manipulate, re-render and deliver new 3D rendered scenes back to the user's browser 22. Any 3D rendering application could be reprogrammed and adjusted to fit this position using the methods of the invention. There any many different 3D rendering engines available as open source or commercially, and by moving these applications server side and using the methods of the invention, their various approaches can be adapted using the methodology disclosed herein to deliver a common Web 3D user experience.

The invention preferably uses the Web 2.0 programming methodology called AJAX—Asynchronous Javascript and XML to create the client side Web 3D scene manipulation tool set. AJAX has emerged as a preferred method for developing sophisticated cross browser, cross platform web applications. AJAX makes client-server programming available to JavaScript developers via Dynamic HTML, resulting in rich, responsive applications hosted in a web browser. AJAX is being used to deploy current applications such as Google Maps™ and Netflix™.

Using this novel combination of the Web Browser, AJAX Tools for client/server communication and a server based Rendering platform, the invention provides a “You click it, you get it now” Web 3D system designed for 3D data delivery for the average consumer. Everyone who has a computer already has a web browser, so no extra software need be downloaded. AJAX-based Web 3D scene tools work with any W3C compliant web browser (Internet Explorer, Firefox etc.). Because the AJAX Web 3D scene controls are delivered with the Hosting Site's HTML, all the AJAX Web 3D scene tools can be managed and updated from a central location, so there are no client side support issues revolving around version issues and compatibility, which presents a major advantage.

The following is a more detailed outline of the invention's unique software process. The process involves the presentation and control of 3D data over a web connection without plugins or third party software. This process offloads the tasks of positioning and rendering a scene to the server while allowing the client to interface with this server given a unique set of AJAX controls. These AJAX controls allow the user to interact with the scene, while only sending the data necessary for the server to re-render the scene. The AJAX controls then take this newly rendered raster image and display it to the user.

The Web Browser event model is used to capture user input and react to the 3D model. Using AJAX technology, one can interface with the model in a manner that allows a next to real time experience. This includes allowing rotations, pans, hit testing, annotations, and other 3D controls that continue to expand upon the business potential and user experience. As an overview of the process that is required to interact with the renderer that resides on the server, the following description outlines the actions of the rotation control from user input to rendered scene output. For purposes of simplification, the discussion will deal only with rotation about the Y axis “pitch”, but the same principles apply to rotation about the X-axis (“roll”) and Z-axis (“yaw”).

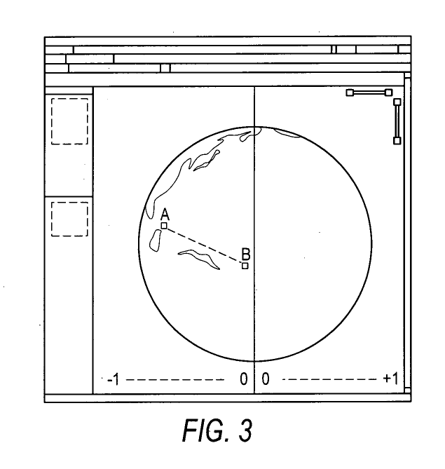

The user will intuitively want to move the mouse from the center of the model to the right or left to achieve a rotation around the positive and negative Y axis. So the center of the image or scene will act as a relative 0 and the far right of the screen +1 and the far left of the screen −1. This means the system must capture the user's mouse position as the user initially depresses the mouse button and then again when the user releases the mouse button. The values that will be called startX and endX will now fall between the values of −1 and +1. Once the system has captured these values it has all the data needed to make the AJAX call to the server to render the new image. This process can be seen in FIG. 3.

The client navigation interface may involve a client proxy model which is displayed on the client Web Browser. The client proxy model is a simplified wire-frame version of the model to be manipulated that is overlaid upon the server-rendered model when the user clicks on the model to manipulate it. The client proxy model can then be manipulated (rotated, tilted, zoomed) in real-time by the user so that the user receives immediate feedback without having to wait for the server-rendered image. When the client browser receives an updated server-render, the client proxy model disappears.

In the case of FIG. 3 the initial click point A is stored in a variable startX. This value will be −0.65 in the example above. The user then dragged his mouse to position B where he let his finger off the button that he pressed in A. This position is stored in endX and has a value of −0.1. These values are then sent to the server using an AJAX call.

The following process can be outlined with the following pseudo code:

```
OnMouseClickEvent:
  startX: store normalized distance from center of model in startX.
  Rotating: true;
OnMouseUpEvent:
  if( Rotating is true ):
    endX: store normalized distance from center of model in endX.
    Call: AJAXMethod.
AJAXMethod:
  send startX and endX to server.
  When server respondes:
    execute script that server returns. ( update image )
```

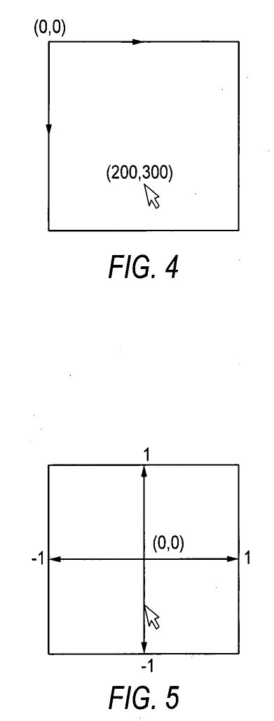

FIG. 4 illustrates the browser space coordinates. FIG. 5 illustrates the normalized trackball space.

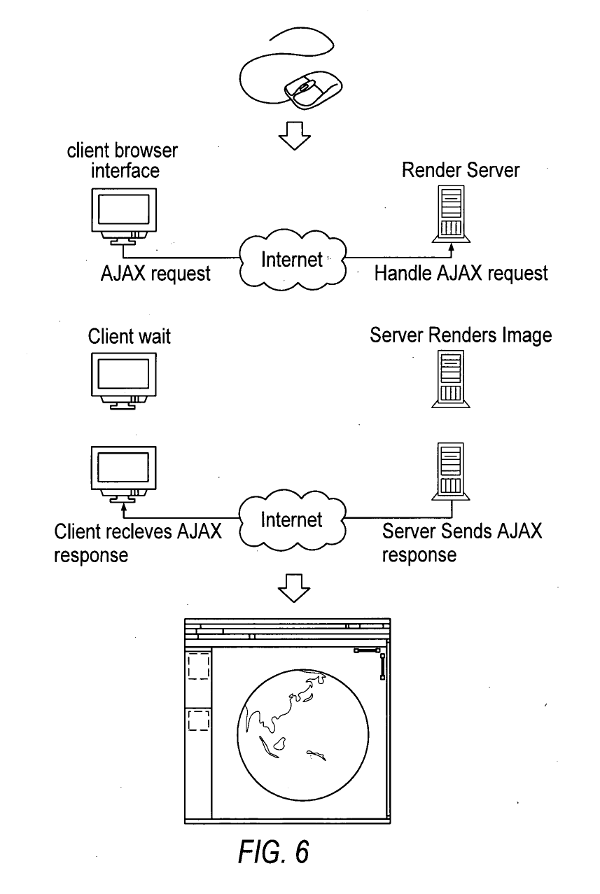

The server model is illustrated in FIG. 6 as follows. The server is a rendering and interprocess communication server. On startup the process initializes the rendering device and network device, it then listens for requests from client processes (AJAX enabled browsers). When it receives a client request, the server grabs the AJAX request variables and initializes a viewport and transforms the geometry into the scene. It next performs any lighting and shading requests on the scene before it does a final render to the rendering device. The rendering buffer is then dumped to a JPG image and an AJAX response is generated back to the client. This response will include the new image to load as well as any other information that the client has requested.

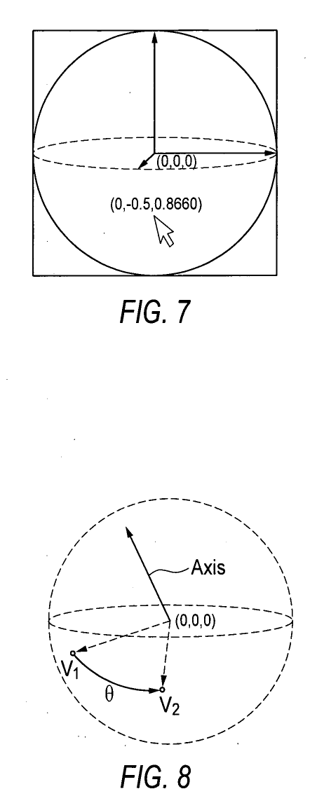

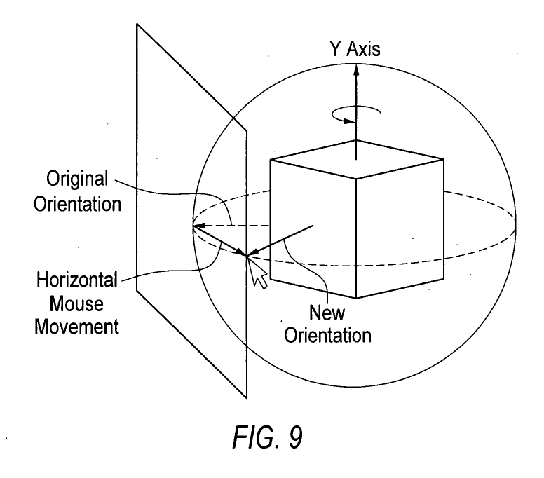

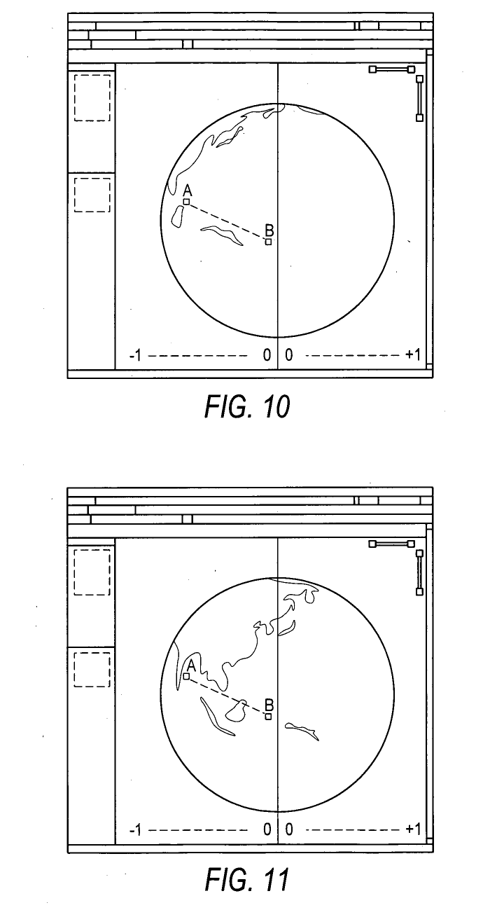

In the example above the client has sent two variables over an AJAX connection to the server. The server now has to create a rotation from these two values. This is done by projecting the values onto a surface of a sphere and coming up with a Quaternion to represent the rotation required to rotate point A to point B (FIGS. 7, 8). Once one has the Quaternion one can convert this into a rotation Matrix that OpenGL or other rendering API can use to rotate the geometry in the scene (FIG. 9). This rotation is then applied to the scene and a final render is produced. Once one has converted the pixel data into a JPG on the server, one then sends, via AJAX response the location of this JPG to the client. The client can then form another request to replace the current image on the screen with the new image at the location that it has received. FIG. 10 illustrates the initial image before rotation. FIG. 11 illustrates the image after rotation is applied.

The same client navigation—server update model described for rotation is also applied to other transformations of the world models and camera. Examples are: a) Zoom in/out—Camera is moved towards/away from the camera look-at point; b) Tilt—Camera is rotated about the look-at point.

Looking next at the Response and Client Display, the response back to the client contains the new location of the JPG on the server. This allows for client code to access the current image and switch the source to the new location. This will cause the browser to make another asynchronous request to the server for the JPG image. The JPG is then sent to the client where the browser renders the new image in place of the old one. In addition the system may send other information and state to store on the client. This allows the system to translate browser events into a 3D scene and generate output to the browser that the browser may digest without the aid of any plugins. With each returned image from the renderer, the server may also include simultaneous XML formatted data regarding specific non-image information relating to that Image, i.e. hotspots, links, coordinates information, points of interest etc. Client-Server: Collaborative Sessions

The present invention also provides other derivatives features. There may be a Collaboration feature. Because the output of the renderer is a W3C defined bitmap, typically JPEG, one user may “drive” the scene and multiple unlimited users may “watch” because the same re-rendered bitmap image can be delivered simultaneously to multiple users in multiple web browsers. By centralizing the model on the server and making and storing all the 3D scene changes on the server it is simpler, faster and more efficient to update the 3D scene collaborators with a new low resolution proxy of the new scene and progressively update them all with higher detailed proxy information over time, rather than pushing either a full, complete model of the new 3D scene, or even the difference geometry update to each collaborator.

In a Collaborative Session, multiple users may manipulate a common scene. Manipulations made by one user and automatically pushed to all other users. For example:
User A and User B are in a collaborative session manipulating an automobile scene. The automobile is currently red.
User A changes the automobile color to turquoise.
Both User A and User B receive a new render of the automobile in turquoise.
User B adds 20 tires to the automobile.
Both User A and User B receive a new render of the automobile with the new tires.
User B adds an annotation to the tires.
Both User A and User B see the new annotation.

There may also be an Animation feature. Multiple rendered images may be delivered via AJAX methodologies to the user to show a time sequence of events and delivered to the user as a multi-frame animation.

### Object Selection/manipulation

The user in the present invention can select particular objects in the 3D scene by clicking on the object, causing a request to the server to select it. The user can then interrogate that object or group of objects, annotate the object, attach information to an object and/or search such annotations or information, or remove the object. Methods of interactive annotation and searching which can be used are disclosed in the applicant's co-pending international patent application no PCT/CA2007/001173 filed 29 Jun. 2007 entitled “Method and System for Displaying and Communicating Complex Graphics File Information” which is incorporated herein by reference.

In this way the user can view and interact with non-geometric information in the image. for example a 3D model could be used as a password system in that the user would be required to spin a 3D “lock tumbler combo” to enter the correct combination before being permitted to access a web site.

There may also be a 3D Data Selection & Delivery Method. The system may be used to navigate to the final 3D scene and then that data is delivered to the user as traditional 3D vector data to be utilized by a client-side 3D application.

The present invention is also be beneficial for usage with commercial applications such as Adobe Flash™ and Adobe Acrobat™ that although they follow a privately generated specification for graphics and communication protocols and are less ubiquitous than the web browser, may be used in the place of the web browser to drive the server side rendering process.

The foregoing approach also solves many display problems on mobile devices such as cell phones in that most cell phone browsers can display a JPEG image and if properly configured, an Adobe Mobile Flash

Viewer can control and display images from the server side renderer as well.

### Server: VRAM Management

Currently rendering of 3D scenes is performed using a 3D graphics card containing: a) one or more Graphics Processing Units (GPUs); and b) Video Random Access Memory (VRAM). To render any one scene, the VRAM of the graphics card must be loaded with the contents of the scene, which has ben stored in the hard drive, including: scene geometry, at minimum consisting of vertices and faces; scene textures, which are mapped onto the faces of geometry; and scene transforms, defining the viewport and virtual camera. The most expensive hardware component is the VRAM and so maximizing the effective use of the VRAM is preferred. The invention may therefore use a preferred form of VRAM management.

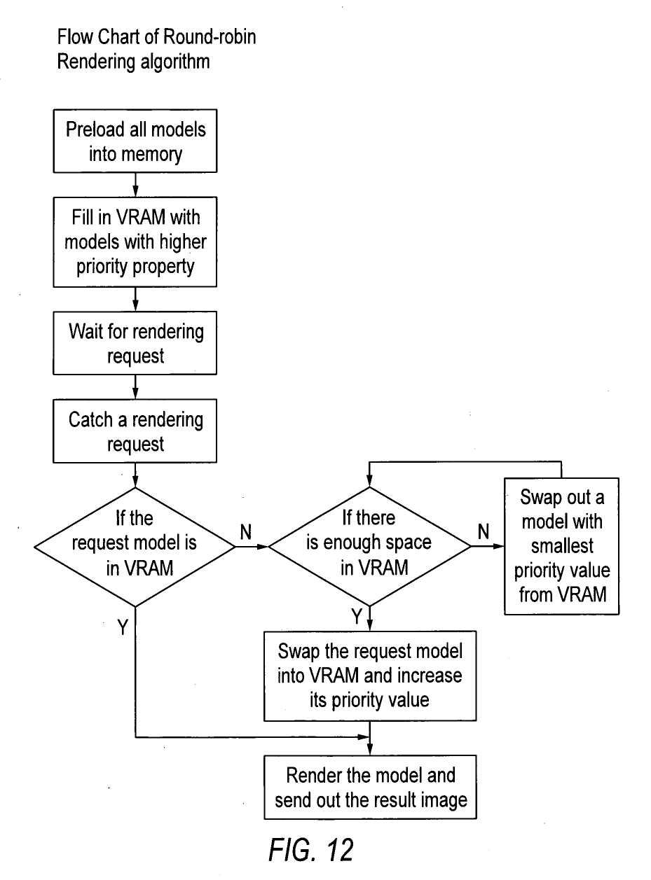

The server used in the present invention maintains a pool of scenes to be rendered. The following describes the simple management of VRAM when rendering multiple scenes. As the Render Server is required to render any one of a number of scenes on demand, and there is a limited amount of VRAM to store the scene, it is desirable to be able to swap in a new scene if it is not already loaded in VRAM. A simple algorithm referred to as a Round-robin Rendering algorithm, (see FIG. 12) assigns a priority property to each scene, such that when it is needed to load an off-VRAM scene, as many scenes as required are swapped out, from lowest priority first, until there is enough space to load the off-VRAM scene for rendering. The priority assigned is based on keeping the most heavily-accessed scene in VRAM. This priority can dynamically change to match actual access patterns over time.

### Server: Render Request Sorting

Another method for further optimizing render requests is to sort them by scene. Because the time required to switch from one scene to another is significant in terms of processing time, it is preferable to minimize the number of scene switches.

For example, during a period of one second, the server may receive the following scene render requests in order:
Client A: Scene 1
Client B: Scene 2
Client C: Scene 1
Client D: Scene 2
Client E: Scene 1
Client F: Scene 2

Assuming a scene switch takes 0.1 seconds and rendering a scene takes 0.1 seconds, ignoring all other factors, it would take a total of 1.2 seconds ((0.1+0.1)×6 ) to process and render the requests. If the requests are re-ordered to minimize the scene switches:
Client A: Scene 1
Client D: Scene 1
Client B: Scene 1
Client E: Scene 2
Client C: Scene 2
Client F: Scene 2

This would only take a total of 0.8 seconds ( 0.1×2+0.1×6) to process and render the requests.

### Server: Multi-card Rendering

Some high-end applications support multiple 3D graphics cards rendering in parallel using computer mainboards that support multiple-card configurations. The render server of the present invention is preferably designed to maximize rendering throughput by pre-loading scenes among the available graphics cards as if it had one combined pool of VRAM, then extending the VRAM Management (see Server: VRAM Management above) to handle the combined pool of VRAM. In addition to utilizing parallel rendering of different scenes, it is possible to load the same scene on more than multiple cards to accommodate heavy usage of that scene.

### Client-Server: Communication Channels

The client in the present invention, which may run on a web browser or a dedicated application outside of a web browser environment, primarily takes user input to manipulate the scene. Examples of such manipulation are: i) Rotate the scene; ii) Translate the camera within the scene; iii) Remove an object from the scene; and iv) Change a material property of an object in the scene. The manipulation of the scene is sent to the render server through an established client-server communication channel. The render server in turn, applies the requested scene manipulations to the scene, and returns to the client, via the client-server communication channel, a newly rendered image. The rendered image is typically in a common web browser-compatible format such as JPEG or PNG.

Any number of protocols may be used to implement the client-server communication channel. The following are examples. In a standard web browser environment, AJAX (Asynchronous Javascript and XML) may be used by the client to send requests and receive the resulting renders. Or in a standard web browser environment, a simple HTTP request may be used. In a standard web browser environment using a Adobe Flash plug-in, an XML Socket connection may used. In a dedicated non-web browser application, any number of protocols supported by the underlying operation system may be used.

### Client-Server: Dual-Rendering

The invention may use Dual-Rendering to create a more seamless and responsive experience for the user. Dual-Rendering involves a server scene stored only on the render server. A client (or proxy) scene is stored in the client computer. The characteristics of a server scene are that the scene data is stored only on the render server. It utilizes the maximum potential of the server's ability to render images that are high-resolution and photo-realistic. The rendering is done in real-time, with a large memory footprint, a large number of geometries (vertices, faces, normals, etc.), high-resolution, detailed textures and a large number of lights. The characteristics of a client (proxy) scene are that the scene data is transferred from the server to the client. The client (proxy) scene utilizes the maximum potential of the client computer's ability to render images that are visually representative of the high fidelity scene. Rendering is done in real-time so that when the user manipulates the scene using his or her mouse or keyboard interface, he/she receives immediate feedback without server intervention. It has a small memory footprint, and is small enough to be downloaded to the client in a short amount of time and to store in the client memory, with a small number of geometry (vertices, faces, normals, etc.), and low-resolution textures. The system can be dynamic in nature to adjust to the capabilities of the client computer and the available network bandwidth between the client and the server.

The primary concern of the client (proxy) scene is the ability of the client computer to manipulate and render the scene locally in real-time, which is generally considered at least 4 frames per second. To achieve this, the server can send to the client either: a) a minimal client proxy scene that renders reasonably quickly on the lowest-common-denominator of client computers, or; b) a scene (referred to as a client-optimized proxy scene) that renders reasonably quickly on the specific client computer. In the case of a minimal client proxy scene, it typically must satisfy the criteria that the lowest number of vertices and faces possible to visually represent the full server scene are used, and it is untextured, i.e. flat-shaded with a single color. In this case of a client-optimized proxy scene, the following steps are taken. The client program running under Javascript or Adobe Flash in the case of a web browser client application will measure the computer's rendering speed and capabilities. The capabilities will be stored on the client computer for future reference and retrieval (as a cookie in the case of a web browser). The server will provide a scene with a fidelity that matches the capabilities of the client computer. The greater the rendering capabilities of the client computer, the closer the client scene characteristics will be to the server scene characteristics.

### Client-Server: Progressive Rendering

A further preferred aspect of the invention utilizes asynchronous and progressive scene downloads of client-optimized proxy scenes. It may be the case that a client-optimized proxy scene may render well and quickly on a client computer, but because of the client-server bandwidth, takes an unreasonably long time to download to the client. In this case, asynchronous and progressive scene downloading may be used. For example, upon first initiation between the server and the client, the server pushes a minimal client proxy scene to the client. Because of the minimal size, the user can interact with the scene after a minimal amount of wait time. In the background (asynchronously), the client program will receive higher-fidelity characteristics from the server, with higher-level geometry and detailed textures, and more scene objects (e.g. light fixtures and furniture added to the once empty room).

Asynchronous and progressive scene downloading may also be used to pre-load localized scene areas to the client based on occlusion. In this example, the client will progressively pre-load localized portions of a scene only as needed, based on the assumption that the user will navigate to the adjoining localized area. For example, a scene is composed of adjoining rooms in a building, Room A, Room B and Room C, all in series. Upon first initiation between the server and the client, the server pushes a minimal client proxy scene of Room A to the client. Because of the minimal size, the user can interact with the scene after a minimal amount of wait time. There is no need to render Room B on the client computer and Room B is occluded by the walls of Room A. In the background (asynchronously), the client program will receive Room B of the same scene. When the user moves the camera from Room A into the adjoining Room B, Room B is rendered. In the background (asynchronously), the client program will receive Room C of the same scene.

### Client-Server: Pre-Rendered Client Proxy Scene

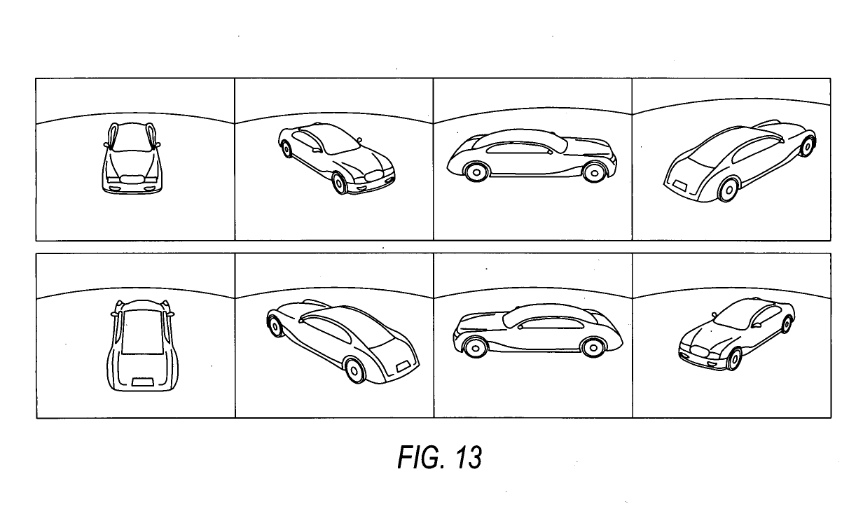

Another alternative to uploading 3D scene geometry and/or textures to the client to be rendered in real-time by the client application, is to upload pre-rendered images. The pre-rendered images represent a discrete, finite set of user manipulations. For example, if user manipulations are limited to rotating an automobile about the vertical axis at 45-degree increments, the system can display on the client computer one of eight pre-rendered frames (see FIG. 13). Thus when the user clicks the rotate-clockwise button, the next frame is displayed in the sequence representing the rotated scene. Because these frames are pre-loaded on the client, the user receives real-time feedback. This pre-loaded, prerendered interactive scene approach is used by QuickTime (e.g. http://www.apple.com/iphone/gallery/360/) and other applications.

A novel approach to pre-rendered images is using the render server to render these frames on-demand for the client, based on the client's current state and the user's scene manipulations. For example, a current automobile view is the front view (frame 1 of FIG. 13). The user sets the automobile body color to turquoise. The render server immediately renders a new frame 1 of the automobile in turquoise and sends to client. If this is cached on the render server, the cached image is sent. The client then displays the new frame 1. Asynchronously, the render server renders all remaining frames 2-8 of the automobile in turquoise, sending each to the client to be replaced as quickly as it can. If these are cached on the render server, the cached frames are sent. Low-resolution frames can also be rendered and sent to the client as this speeds up the update. High-resolution frames can then be progressively sent as they are available. Additional in-between frames can also be progressively sent as they are available (e.g. 128-frames instead of just 8 frames). More complex manipulations can also be represented using this method. For example, based on the current camera position, additional frames can be rendered to represent movement of the camera forward and backward, up or down. Using this render-frames-on-demand, the client is not burdened with storing complex scenes in memory and rendering.

While the invention preferably uses the Web 2.0 programming methodology called AJAX—Asynchronous Javascript and XML to create the client side Web 3D scene manipulation tool set, it will be apparent to those skilled in the art that other asynchronous programming methodologies having two way socket connections will also be useful such as FLASH™ or SILVERLIGHT™.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within its true spirit and scope.

What is claimed is:

1. A method of delivering and interactively displaying three-dimensional graphics images to a user's client computer provided with standard web browser software for accessing and interactively communicating with a server via a computer network, comprising:
a) providing a web server provided with data storage to store three-dimensional graphics image data, and application software adapted to render three-dimensional graphics images from said three-dimensional graphics image data, and to respond to commands from the user's web browser to render, deliver back to a user's browser, manipulate, re-render and re-deliver to a user's browser three-dimensional graphics images;
b) the user requesting a three-dimensional graphics image to be rendered;
c) said server retrieving the three-dimensional graphics image data for the requested image and rendering the requested three-dimensional graphics image;
d) said server converting said rendered image to a file format which is readable by said user's browser software;
e) said server delivering said converted rendered file to said user's browser.

2. The method of claim 1 comprising the further steps of:
f) the user requesting a manipulation of the delivered three-dimensional graphics image;
g) said server re-rendering the three-dimensional graphics image with the requested manipulation;
h) said server converting said re-rendered image to a file format which is readable by said user's browser software;
i) said server delivering said converted re-rendered file to said user's browser.

3. The method of claim 1 wherein said format which is readable by said client's browser software is W3C standard bitmap format.

4. The method of claim 3 wherein said W3C standard bitmap formats is JPEG or PNG file format.

5. The method of claim 1 wherein said user request is made by an asynchronous communication.

6. The method of claim 5 wherein said user request is made by Asynchronous Javascript and XML commands.

7. The method of claim 1 wherein said user request is made by a communication selected from the group consisting of HTTP, Adobe Flash plug-in, and XML Socket connection.

8. The method of claim 2 wherein said user request for manipulation is made by Asynchronous Javascript and XML commands.

9. The method of claim 1 wherein said client can select an object and annotate said object in said image and said annotations can be saved and viewed by said user.

10. The method of claim 2 wherein said manipulation is selected from the group consisting of rotation, pan, tilt, zoom in, zoom out, hit testing and annotation.

11. The method of claim 2 wherein a proxy model is displayed to said user for requesting manipulation of said image by said user, said proxy model being a simplified model overlaid on said image which is modified in response to the user's request for manipulation prior to re-rendering and delivery of said image by said server.

12. The method of claim 2 wherein said user's computer is provided with a mouse and said user requests manipulation of said image by clicking on said image.

13. The method of claim 12 wherein by clicking on said image said user communicates a rotation of said image by providing two variables defining said rotation.

14. The method of claim 1 wherein said server also delivers non-geometric information about the image to the user with said image.

15. The method of claim 2 wherein multiple users manipulate a single image, whereby a modification requested by any one of said multiple users is communicated to said server and said server re-renders said image with said modification and re-delivers said re-rendered image to said multiple users.

16. The method of claim 2 wherein asynchronous and progressive downloads are used to progressively improve said proxy.

17. The method of claim 2 wherein pre-rendered images representing a finite set of user manipulations of said image are communicated to said user by said server in advance of said requests for manipulation.

18. A computer implemented system for delivering and interactively displaying three-dimensional graphics images to a user's client computer provided with standard web browser software for accessing and interactively communicating with a server via a computer network, comprising:
a) a web server provided with data storage to store three-dimensional graphics image data, and application software adapted to render three-dimensional graphics images from said three-dimensional graphics image data, and to respond to commands from the user's web browser to render, deliver back to a user's browser, manipulate, re-render and re-deliver to a user's browser three-dimensional graphics images;
b) computer-implemented means for the user to requesting a three-dimensional graphics image to be rendered;
c) computer-implemented means for said server to retrieve the three-dimensional graphics image data for the requested image and render the requested three-dimensional graphics image;
d) computer-implemented means for said server to converting said rendered image to a file format which is readable by said user's browser software;
e) computer-implemented means for said server to deliver said converted rendered file to said user's browser.

19. The system of claim 18 further comprising the further steps of:
f) computer-implemented means for said user to request a manipulation of the delivered three-dimensional graphics image;
g) computer-implemented means for said server to re-render the three-dimensional graphics image with the requested manipulation;
h) computer-implemented means for said server to convert said re-rendered image to a file format which is readable by said user's browser software;
i) computer-implemented means for said server to delivering said converted re-rendered file to said user's browser.

20. The system of claim 18 wherein said format which is readable by said client's browser software is W3C standard bitmap format.

21. The system of claim 20 wherein said W3C standard bitmap formats is JPEG or PNG file format.

22. The system of claim 18 wherein said user request is made by an asynchronous communication.

23. The system of claim 22 wherein said user request is made by Asynchronous Javascript and XML commands.

24. The system of claim 18 wherein said user request is made by a communication selected from the group consisting of HTTP, Adobe Flash plug-in, and XML Socket connection.

25. The system of claim 19 wherein said user request for manipulation is made by Asynchronous Javascript and XML commands.

26. The system of claim 19 wherein said manipulation is selected from the group consisting of rotation, pan, tilt, zoom in, zoom out, hit testing and annotation.

27. The system of claim 19 wherein a proxy model is displayed to said user for requesting manipulation of said image by said user, said proxy model being a simplified model overlaid on said image which is modified in response to the user's request for manipulation prior to re-rendering and delivery of said image by said server.

28. The system of claim 19 wherein said user's computer is provided with a mouse and said user requests manipulation of said image by clicking on said image.

29. The system of claim 28 wherein by clicking on said image said user communicates a rotation of said image by providing two variables defining said rotation.

30. The system of claim 18 wherein said server also delivers non-geometric information about the image to the user with said image.

31. The system of claim 18 comprising multiple users which manipulate a single image, whereby a modification requested by any one of said multiple users is communicated to said server and said server re-renders said image with said modification and re-delivers said re-rendered image to said multiple users.
